(19) United States
(12) Patent Application Publication
(10) Pub. No.: US 2007/0208187 A1
(43) Pub. Date: Sep. 6, 2007

(54) Low-linolenic soybean oil process

(75) Inventor: Jerry E. Tysinger, Warsaw, NC (US)

Correspondence Address: WILLIAM J. MASON;MACCORD MASON PLLC, POST OFFICE BOX 1489, WRIGHTSVILLE BEACH, NC, 28480, US

(73) Assignee: Carolina Soy Products LLC

(21) Appl. No.: 11/712,712

(22) Filed: Mar. 1, 2007

Related U.S. Application Data
(60) Provisional application No. 60/778,341, filed on Mar. 2, 2006.

(51) Int. Cl. C11B 1/00; A23D 9/00

(52) U.S. Cl. 554/8; 426/601

(57) ABSTRACT

Soybean oil with an improved frylife is produced from soybeans having less than 3% by weight C18:3 acids based on the total content of free fatty acids by heating the soybeans at a time and temperature sufficient to enable extraction of oil from the soybeans; mechanically pressing the soybeans to separate the oil; and heating the oil at a temperature of up to about 500° F. under a vacuum to remove free fatty acids from the soybean oil.

This application claims the benefit of the filing date of U.S. Provisional Application Ser. No. 60/778,341, filed Mar. 2, 2006.

### BACKGROUND OF THE INVENTION

(1) Field of the Invention

The present invention relates generally to a process for extracting and refining vegetable oils and to the resultant product, and in particular to the production of extended frylife, non-hydrogenated soybean oils from low-linolenic soybeans by a combination of mechanical extraction and physical refining.

(2) Description of the Prior Art

Soybean oil production involves several steps that are necessary to render the soybean oil suitable for human consumption. These production steps may be broadly characterized as 1) soybean preparation, 2) oil extraction, and 3) oil refining. Soybean preparation generally includes the steps of cleaning, drying, cracking, and dehulling.

The great majority of commercial soybean oil production processes extract or separate the oil from the soybean meal by a process known as solvent extraction. In the solvent extraction process, the prepared beans are first flaked to provide a large surface area. A solvent, commonly hexane, is then pumped through the soybean flakes to dissolve the oil in the hexane, separating approximately 99.5% of the oil from the meal. The hexane is then separated from the oil and recycled.

The crude oil resulting from the solvent extraction must then be subjected to additional treatments, collectively called “refining”, to remove various materials in order for the oil to be suitable for consumption. These materials include hydratable and non-hydratable phospholipids, free fatty acids, and various color and flavor components. Crude soybean oil contains phosphorous compounds called hydratable phospholipids, and small amounts of calcium and magnesium that complex with a portion of the phospholipids to form non-hydratable phospholipids. Hydratable phospholipids are normally removed by a process known as “degumming”, in which the oil is agitated or otherwise intimately combined with water to precipitate gums from the oil. The gums are then removed by centrifugation.

These precipitated gums can be used as a feed additive, or evaporated to remove moisture. The end product, lecithin, has various end uses such as in food emulsifiers. The degummed oil is dried under vacuum to remove any water. Removal of non-hydratable phospholipids is considerably more difficult and expensive, requiring further chemical treatment, typically chemical refining, to break the chemical bonds between the calcium or magnesium ions and the phospholipids, followed with extensive bleaching of the oil.

In most processes, free fatty acids are removed from the oil by a process known as caustic refining, also called chemical or alkali refining, in which the oil is mixed with a caustic material, such as sodium or potassium hydroxide, which undergoes a saponification reaction with the acids, forming soaps that are then removed by centrifugation. Non-hydratable phospholipids are removed along with the free fatty acids. Chemical refining soybean oil is an expensive process, requiring a large investment in capital equipment. In addition, a significant quantity of the oil is captured by the soaps, adversely affecting oil yield. Also, the caustic refining process produces soapstock, which has little commercial value, and is difficult to dispose of without environmental problems.

Conventional refining processes also involve some bleaching of the soybean oil to remove color pigments that adversely affect the color of the oil. Finally, chemicals that add flavors to the oil are removed by a process known as “deodorization”, which is essentially a form of physical distilling, in which the oil is subjected to high temperatures under a vacuum for a short period of time, which is sufficient to remove the flavor-causing components, but insufficient to break down non-hydratable phospholipids.

A major use of soybean oil is in deep frying of foods, such as chicken, fish, french fries, etc., either in the production of pre-cooked packaged foods, or in the preparation of foods for on-premise or carry-out consumption in restaurants and other commercial establishments. In deep frying, a container or vat is filled with cooking oil that is heated to a frying temperature, normally around 350° to 375° F. The uncooked food is then immersed in the hot oil for a sufficient time to effect the desired cooking, and then removed for serving or packaging.

Some of the oil in the vat is lost during cooking due to absorption and evaporation. The oil is replenished by adding fresh oil to the oil remaining in the vat, and the oil is reused. This procedure is repeated until the oil becomes unusable, as indicated by darkening of the oil and the food cooked in the oil, and/or by the observance of an undesirable taste or appearance in the food being cooked.

Non-hydrogenated soybean oil produced by solvent extraction and caustic refining is unsuitable for use in commercial frying operations due to its limited frylife. Such oil has a maximum frylife of only about 4-5 fry cycles, a cycle being the frying of one batch of food. Replacement of the oil at this frequency is uneconomical. In order to extend the frylife of soybean oil to a commercially acceptable number of fry cycles, preferably at least about 30 fry cycles, refined soybean oil is normally at least partially hydrogenated. Hydrogenation of solvent extracted, caustic refined soybean oil reduces the percentage of C18:3 acids (linolenic acid). It is commonly believed that the presence of C18:3 acids contribute to the rapid deterioration, and thereby limited frylife, of solvent extracted, caustic refined soybean oil.

Saturation or hydrogenation of C18:3 acids, however, reduces the healthful properties of soybean oil. Therefore, attempts have also been made to reduce the C18:3 or linolenic acid content of soybean oil by genetically modifying or selective breeding the soybean, thereby enabling the production of non-hydrogenated soybean oil having a C18:3 content of significantly less than the 6-8% by weight C18:3 acids based on the total content of free fatty acids found in conventional soybeans.

U.S. Pat. No. 5,981,781 to Knowlton, issued Nov. 9, 1999, is an example of prior art describing soybean oil obtained from generically modified soybeans. The genetically modified soybean oil in the Knowlton patent contains greater than 65% C18:1 (oleic acid) and a combined C18:2 (linoleic acid) and C18:3 content of less than 20% of the fatty acid moieties in the oil. Examples in the Knowlton patent show oils with a C18:3 content of 2.2%. This genetically modified soybean oil is said to have “high oxidative stability”, which is defined as being less susceptible to oxidative degradation when compared to normal soybean oil. Soybean oils with similar compositions are described in U.S. Pat. No. 5,714,668 to Fehr et al., issued Feb. 3, 1998. Fehr et al. describe soybean oils with less than 3%.

Commonly assigned U.S. Pat. No. 6,511,690, issued Jan. 28, 2003; U.S. Pat. No. 6,753,029, issued Jun. 22, 2004; and U.S. Pat. No. 6,906,211, issued Jun. 14, 2005, (herein the “Tysinger et al. patents”), the three patents incorporated herein in their entireties by reference, describe an improved refining process combining mechanical extraction with physical refining and the resultant products. As noted in the Tysinger et al. patents, mechanical oil extraction and physical refining were previously known separately, but had not been used in combination, and these properties of the resultant oil have not been appreciated.

In the prior art mechanical oil separation process known as expelling, dehulled beans are extruded through a screw press to frictionally heat the beans and rupture the oil cells. Within the screw press, the beans are subjected to high pressures and frictionally-generated high temperatures for a short period. The crushed, oil-containing meal is then pressed to separate most of the oil from the meal. This process has been rarely used to process soybeans due to the fact that about 25% of the soybean oil is left in the meal.

Physical refining has been used for oils that are naturally low in non-hydratable phospholipids, such as lauric oils, particularly palm oil. In physical refining, the oil is vacuum distilled at high temperatures, e.g., from about 450° F. to about 500° F., to separate more volatile components from the oil. This process is used to remove various flavor components, and will also remove free fatty acids. However, the process alone is not viable for removing free fatty acids from oils such as soybean oil, which contains higher levels, i.e., more than 20 ppm based on elemental phosphorous content, of non-hydratable phospholipids. The high temperatures required for physical refining tend to break down the non-hydratable phospholipids that are present in the soybean oil, producing chemical compounds that cause an unacceptable flavor and color.

In the process described in the Tysinger et al. patents, soybean oil is mechanically separated from prepared soybeans by first rapidly heating the beans to a temperature of from about 300° F. to about 370° F., preferably from about 315° F. to about 335° F., followed by mechanically pressing the oil from the beans. Desirably, the beans are crushed during or after heating to assist in freeing the oil from the remainder of the soybeans, i.e., the meal. After degumming and bleaching, the soybean oil is physically refined to remove free fatty acids and flavor components by heating the oil in a distillation column to a temperature of from about 450° F. to about 500° F., and preferably for from about 460° F. to about 480° F., to distill off the free fatty acids and flavor materials.

While the above prior art provides directional improvements in the increased stability of soybean oil, there is a continuing demand for soybean oil having even greater frylife.

### SUMMARY OF THE INVENTION

In accordance with the present invention, it has been discovered that this stability is achievable by processing low linolenic soybeans, i.e., soybeans with less than 3% by weight C18:3 acids based on the total content of free fatty acids. Preferably, the soybeans have a C18:3 content of less than 2%, and even more preferably a C18:3 content of less than 1%. The soybeans also desirably have a C18:1 content of greater than 65% as described in the Knowlton patent, and preferably a C18:1 content of greater than 75%, and even more preferably a C18:1 content of greater than 80%.

In one embodiment of the invention, soybeans having the above properties are heated to a temperature and at a time sufficient to enable extraction of the soybean oil from the soybeans. Generally, a higher temperature will require a shorter heating time, while a lower temperature will require an extended heating time to adequately “roast” the beans prior to extraction of the oil.

When following the procedure described in the above-noted Tysinger patents, the cleaned and dehulled soybeans are heated at a temperature of at least 300° F., and preferably from about 315° to about 335° F., for less than about 60 seconds. Alternatively, as described in copending and commonly assigned U.S. patent application Ser. No. 11/201,948, to the present inventor, the soybeans are heated at a temperature of 220° F. to 260° F. for a period of from 45 to 60 minutes, preferably, between about 230° F. and 260° F. for between 50 minutes and 60 minutes. Other combinations of temperatures and times within the range of 220° F. to 370° F. for up to 60 minutes may be used in heating the soybeans, with shorter times being selected at the higher temperatures to prevent burning of the soybeans.

After heating, the soybeans are mechanically pressed, e.g., with a screw extruder, also known as an expeller, to remove up to about 74% to about 76% of the oil from the beans, leaving a soybean meal that includes from about 4% to 8% soybean oil. However, this meal has a substantially higher nutritional value than soybean meal from conventional solvent extraction, with the resultant higher selling prices at least partially offsetting the oil loss.

The crude soybean oil is then degummed by intimately mixing the crude soybean oil with water, which may contain citric acid or a similar organic acid, to form gums of the hydratable phospholipids, which are then removed from the crude oil, e.g., by centrifuging. The degummed oil is then bleached with bleaching materials, such as clay, silica gel, and if needed for damaged beans, sodium metasilicate. The oil is then vacuum dried and filtered.

At this stage, the oil is a useful product known as refined and bleached oil. However, for many applications it is desirable to further process the oil to remove free fatty acids and components that contribute to the color and flavor of the oil. In the present process, it is possible to remove the free fatty acids without the caustic refining required in prior art processes. Instead, the free fatty acids are removed at the same time as the flavor and color components are removed during physical refining.

As noted earlier, removal of free fatty acids by physical refining has not been feasible due to the large amount of non-hydratable phospholipids in the oil, which degraded under the high temperatures required for physical distillation. In the present process, however, the amount of non-hydratable phospholipids is generally less than 2.0 ppm based on the weight of elemental phosphorous in the compounds as a result of the mechanical extraction. After silica treatment and bleaching, the phosphorous content will be less than 1 ppm. This insignificant amount of phosphorous has no affect on oil flavor or stability.

During the physical refining stage of the invention, free fatty acids and flavor components are removed from the oil by heating the oil under vacuum in a distillation column to a temperature of from about 450° F. to about 500° F., and preferably for from about 460° F. to about 480° F., to distill off the free fatty acids and flavor materials. By industry standards, the final oil should contain less than about 0.05% free fatty acids.

In a second embodiment of the invention, soybean oil is extracted from the low-linolenic acid soybeans as above defined by partial solvent extraction in accordance with the process defined in applicant's copending U.S. patent application Ser. No. 10/677,015, filed Sep. 30, 2003, incorporated herein in its entirety. Up to about 85%, preferably from about 60-75%, of the soybean oil present in the low-linolenic soybeans is removed by solvent extraction, resulting in first extracted soybean oil and soybean meal containing the remainder of the soybean oil.

The amount of solvent used in partial solvent extraction will vary depending on the solvent and the condition of the soybeans. Normally, however, the ratio of solvent to available soybean oil in the present process will be less than the 1:1 ratio conventionally used in solvent extraction, e.g., from about 0.25:1 to about 0.95:1.

This first extracted oil, normally after degumming and bleaching as described above, is further processed to remove free fatty acids and components that contribute to the color and flavor of the oil. Free fatty acids in solvent extracted soybean oil can be removed by caustic refining by intimately mixing the oil with an alkali, e.g., potassium or sodium hydroxide, to react with the free fatty acids, producing soap stock that is removed by centrifugation. As a result of the lower ratio of solvent to oil, the solvent extracted oil can also be refined using physical refining as described above.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A process for producing soybean oil with an improved frylife from soybeans having less than 3% by weight C18:3 acids based on the total content of free fatty acids comprising:
a) heating said soybeans at a time and temperature sufficient to enable extraction of oil from said soybeans;
b) mechanically pressing said soybeans to separate said oil; and
c) heating said oil at a temperature of up to about 500° F. under a vacuum to remove free fatty acids from said soybean oil.

2. The process of claim 1, wherein said soybeans have greater than 65% by weight C18:1 acids based on the total content of free fatty acids.

3. The process of claim 1, wherein said soybeans have less than 2% by weight C18:3 acids based on the total content of free fatty acids.

4. The process of claim 1, wherein said soybeans are heated at a temperature of from about 220° F. to about 260° F. for between 45 and 60 minutes.

5. The process of claim 1, wherein said oil is heated under a vacuum at a temperature of from about 460° F. to about 480° F.

6. The process of claim 1, wherein from about 74% to about 76% of the oil is removed from the beans by mechanical pressing.

7. The process of claim 1, wherein said soybean oil contains less than about 0.05% free fatty acids after distilling.

8. A solvent extraction free, caustic refining free, process for producing refined soybean oil from soybeans having less than 3% by weight C18:3 acids based on the total content of free fatty acids comprising:
a) heating said soybeans for up to 60 minutes and at a temperature sufficient to enable extraction of oil from said soybeans;
b) mechanically pressing said soybeans to separate said oil; and
c) heating said oil at a temperature of from about 350° F. to about 500° F. under a vacuum to remove free fatty acids from said soybean oil.

9. The process of claim 8, wherein said soybeans are heated at a temperature of from about 230° F. to 260° F. for between 50 and 60 minutes.

10. A process for producing soybean oil with an improved frylife from soybeans having less than 3% by weight C18:3 acids based on the total content of free fatty acids comprising:
a) extracting up to about 85% of the oil from the soybeans to produce first extracted soybean oil and oil-containing meal; and
b) refining said first extracted soybean oil.

11. The process of claim 10, wherein said soybean oil is refined by physical refining.

12. The process of claim 10, wherein said soybean oil is refined by caustic refining.

13. The process of claim 10, wherein said soybeans have less than 2% by weight C18:3 acids based on the total content of free fatty acids.

14. The process of claim 10, wherein said oil is heated under a vacuum at a temperature of from about 460° F. to about 480° F.

15. The process of claim 10, wherein from about 60 to about 75% of the oil is extracted from the low-linolenic acid soybeans.
